(19) United States
(12) Patent Application Publication
(10) Pub. No.: US 2011/0025016 A1
(43) Pub. Date: Feb. 3, 2011

(54) VEHICLE

(76) Inventor: Cornelis J.H. Waaijer, Hague (NL)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/667,660

(22) PCT Filed: Jul. 7, 2008
(86) PCT No.: PCT/NL08/00170

§ 371 Date: Oct. 19, 2010

(30) Foreign Application Priority Data
Jul. 6, 2007 (NL) 1034108

(51) Int. Cl. B62K 15/00

(52) U.S. Cl. 280/287

(57) ABSTRACT

A vehicle (1), comprising a frame (2) and a number of wheels (6, 13). The frame comprises at least two mutually connected frame parts (3, 4), a fixating means (18) and engaging means (21) with which the fixating means is in engagement with the frame parts. The frame parts are freely movable between a fixated situation, in which the vehicle is fit for use, and a non-fixated situation, in which the vehicle is not fit for use, and the fixating means can fixate the frame parts in the fixated situation, wherein the vehicle comprises a coupling (19) to which the fixating means can be coupled, the coupling comprises a securing means (21), and the securing means comprises a lock (56).

The invention relates to a vehicle comprising a frame, a number of wheels on the frame for moving the vehicle over a ground surface, wherein the frame comprises at least two mutually connected frame parts, a fixating means and engaging means with which the fixating means is in engagement with the frame parts.

Such vehicles are for instance known as cycles in which a cable is incorporated as a structural part of the frame. In known cycles with a cable as structural part of the frame, the frame bends or breaks when the frame is loaded by a rider and the cable is absent.

A further development of such cycles is that the cable can be used as a cable lock when the cycle is not in use. When the cycle is then locked with the cable as cable lock, a thief must for instance cut through the cable in order to be able to take the cycle. When the thief then sits on the cycle in order to cycle away thereon, a frame part bends or breaks and the cycle is useless to the thief.

A drawback of these known cycles is that the cycle appears to be fit for use without cable, or is even fit for use for a time. The thief therefore only notices that the cycle is useless to him after he has cut through the cable and has mounted the cycle, or has even already cycled away on the cycle. Even though the thief is likely to leave the cycle behind, the owner of the cycle is then still confronted with a broken cable or even a bent or broken frame part.

The invention has for its object to obviate or at least alleviate this drawback.

For this purpose the invention is distinguished in that the frame parts are connected for free movement relative to each other, wherein the frame parts are freely movable between a fixated situation, in which the vehicle is fit for use, and a non-fixated situation in which the vehicle is not fit for use, and wherein the fixating means can fixate the frame parts in the fixated situation. This measure makes it possible for the frame parts to move relative to each in the non-fixated situation such that it is clearly apparent to a potential thief that the vehicle is not fit for use. This has the advantage for instance that the thief already sees that theft is pointless before the attempt at theft, and he for instance does not then break a means with which the owner has locked the vehicle. In addition, this measure make it possible that in the non-fixated situation the vehicle is not fit for use without a frame part bending or breaking. Relative to the known cycles in which a frame part bends or breaks, this has for instance the particular advantage that, when a thief leaves the vehicle behind after a failed attempt at stealing the vehicle, the owner does not have to have the frame part repaired in order to be able to use the vehicle again. This measure also makes it possible that the frame parts do not break when the frame parts unintentionally move into the non-fixated situation during movement of the vehicle. The frame parts will then move relative to each other and not break. This has the advantage of avoiding injury resulting from a frame part breaking. In the existing cycles a frame part will in many cases either break, or first bend and then break, for instance when the cable breaks, wherein the owner could sustain considerable injuries. In an additional embodiment hereof the frame parts are connected for free pivoting relative tom each other. This measure makes it for instance possible that the size of the vehicle can be reduced by pivoting the frame parts relative to each other. This has the advantage that the vehicle can for instance be carried into the house easily, so that it does not have to remain on the street and the chance of theft is considerably reduced. In a further additional embodiment hereof the frame parts are connected for free pivoting by means of a hinge. A hinge forms a simple, low-maintenance implementation of a free pivoting movement of the frame parts relative to each other. In a further embodiment of the vehicle with hinge the rotation axis of the hinge is oriented substantially horizontally.

In an additional embodiment of the vehicle according to the invention at least one of the engaging means can be placed releasably in the non-fixated situation round the frame parts. This measure makes it possible to place the frame parts in simple manner in the non-fixated situation. If all engaging means are releasable, it is for instance even possible to remove the fixating means from the vehicle, so that it is not possible for someone else to place the frame parts in the fixated situation.

In an additional embodiment of the invention the vehicle comprises a drive which is obstructed in the non-fixated situation. In an additional embodiment hereof the drive comprises a pedal frame, wherein the frame parts are movable relative to each other such that in the non-fixated situation the pedal frame comes into contact with the ground surface. This measure makes it possible that driving of the vehicle is obstructed in the absence of the fixating means, with the advantage that the thief cannot go off with the vehicle. In addition, this measure makes it possible for further driving to be obstructed if the frame unintentionally moves into the non-fixated situation while the vehicle is moving, whereby the vehicle comes to a standstill. This has the advantage that the chance of injury is reduced if the frame unintentionally moves into the non-fixated situation.

In an alternative embodiment hereof the drive comprises a pedal frame on one of the frame parts, a wheel to be driven via the pedal frame on another frame part, and a transmission between the pedal frame and the wheel for driving, wherein the frame parts are movable relative to each other such that the distance between the pedal frame and the driven wheel is greater in the non-fixated situation than in the fixated situation. In this embodiment the driving of the vehicle is also obstructed in the absence of the fixating means. If for instance a rider mounts the vehicle, a tension is then exerted on the transmission such that the drive of the vehicle is obstructed. Because in this embodiment no parts of the vehicle other than the wheels touch the ground surface in the absence of the fixating means, the chance of injury if the frame unintentionally moves into the non-fixated situation during movement of the vehicle is further reduced.

In an additional embodiment of the invention the frame parts are movable relative to each other such that in the non-fixated situation a part of the vehicle other than the wheels comes into contact with the ground surface. This measure makes it possible for movement of the vehicle to also be obstructed without use of the drive. This has the advantage that the thief is also impeded when for instance pushing the vehicle along. In addition, the movement of the vehicle is braked by the part of the vehicle which comes into contact with the ground surface when the frame unintentionally moves into the fixated situation during movement of the vehicle, wherein the vehicle comes safely to a stop.

In an additional embodiment of the invention the frame parts are movable relative to each other such that in the non-fixated situation a decentral part of at least one of the wheels comes into contact with a fixed part of the vehicle. This decentral part can for instance be a tyre. This measure also makes it possible for the movement of the vehicle to also be obstructed without use of the drive, with the advantage that the thief is for instance also impeded when pushing the vehicle along. Because in this embodiment no parts of the vehicle other than the wheels touch the ground surface in the absence of the fixating means, the chance of injury when the frame unintentionally moves into the non-fixated situation during movement of the vehicle is reduced further.

In an additional embodiment of the vehicle according to the invention, the vehicle comprises a coupling to which the fixating means can be coupled. In an additional embodiment hereof at least one of the releasable engaging means comprises the coupling. In an additional or alternative embodiment hereof the coupling comprises a securing means. This measure makes it possible to secure the fixating means to the frame parts. This has for instance the advantage that during movement of the vehicle in fixated situation the fixating means is prevented from coming loose and the frame is prevented from changing to a non-fixated situation. In an additional embodiment hereof the securing means comprises a lock. This measure makes it possible that the owner can for instance prevent others uncoupling the fixating means from the frame parts or, conversely, prevent others coupling the fixating means to the frame part. In the latter case someone other than the owner is prevented from moving the frame from the non-fixated situation into the fixated situation.

In an additional embodiment of the invention the coupling comprises a first coupling part on the fixating means and a second coupling part on the frame part, wherein the vehicle comprises a third coupling part to which the first coupling part can be coupled in the non-fixated situation. This measure makes it possible, after having placed the frame in the non-fixated situation by uncoupling the fixating means, to couple the fixating means again at another position on the vehicle. This has the advantage that the frame cannot be placed in a fixated situation without uncoupling the fixating means. Particularly in combination with a cable as fixating means and a coupling with lock, this measure has the advantage that the cable, when used as cable lock, has a greater reach and no-one other than the owner can place the frame parts in the fixated situation.

In an additional embodiment hereof the first coupling part comprises a pin and the third coupling part a bush into which the pin can be inserted, wherein the length of the bush is smaller than the length of the pin, wherein the third coupling part is located close to one of the wheels in at least the non-fixated situation, and wherein the pin extends into this wheel when it is inserted into the bush. This measure makes it possible that movement of the vehicle is not only obstructed in that the frame parts move relative to each other, but also in that a wheel is blocked. This has the advantage of being a further obstacle to removal of the vehicle by a thief.

In an additional embodiment of the invention the fixating means comprises a cable. This measure enables a very simple and strong realization of the fixating means. Furthermore, a cable can for instance be readily taken along by the owner when he/she leaves the vehicle somewhere with the frame in non-fixated situation, so that someone else cannot place the frame in the fixated situation. Particularly in the case that the coupling between the frame parts and the fixating means comprises a lock, the advantage of a cable as fixating means is that the cable can also be used as cable lock. The owner can then secure the vehicle to for instance another object, such as for instance a cycle rack, a tree, a post, a lamppost, another vehicle or the like, by first uncoupling the cable from one of the frame parts, then placing the cable round the object, subsequently coupling the cable to the frame part again by means of the coupling and finally securing the coupling using the lock.

In an additional embodiment of the invention the fixating means is in contact along the length thereof with one of the frame parts in the fixated situation. This measure makes it possible for the fixating means to have a great length. Particularly in combination with a cable as fixating means and a coupling with lock, this measure has the advantage that the cable has a greater reach when it is used as cable lock. In an additional embodiment hereof a compressible resilient element is arranged at the position of the contact between the fixating means and the frame part. This measure enables the realization of a suspension and prevents damage to the fixating element at the position of the contact with the frame part.

In an additional embodiment of the invention with a compressible resilient element, the compressible resilient element is a rubber body. This measure forms a very simple and effective realization of the compressible resilient element. In an additional or alternative embodiment hereof the compressible resilient element is displaceable along the fixating means and comprises a tapering form. This measure enables adjustment of the suspension behaviour of the vehicle.

In an additional embodiment of the invention the frame comprises at least a third frame part which is connected movably to at least one of the frame parts, wherein the third frame part is fixated by means of the fixating means in the fixated situation and wherein the frame comprises additional engaging means with which the third frame part is in engagement with the fixating means in the fixated situation. This measure makes it possible for frame parts to move relative to each other at more than one position in the frame in the non-fixated situation. This has the advantage that it is more difficult for a thief to move the vehicle along in the non-fixated situation. In addition, this measure makes it possible for the vehicle to be further folded up in the non-fixated situation so that the size of the vehicle can be further reduced. This has the advantage that the vehicle can for instance be taken into the house easily, so that it does not have to remain on the street and the chance of theft is reduced considerably.

In an additional embodiment of the invention the fixating means is adapted as carrying means. This measure makes it possible for instance to easily lift and carry the vehicle. This has the advantage for instance that the vehicle can easily be carried upstairs, thus further reducing the chance of theft.

The present invention will be further elucidated hereinbelow on the basis of a number of exemplary embodiments which are shown schematically in the accompanying figures. These are non-limitative exemplary embodiments. In the figures:

FIG. 1 shows a side view of a vehicle according to the invention in the fixated situation of the frame;

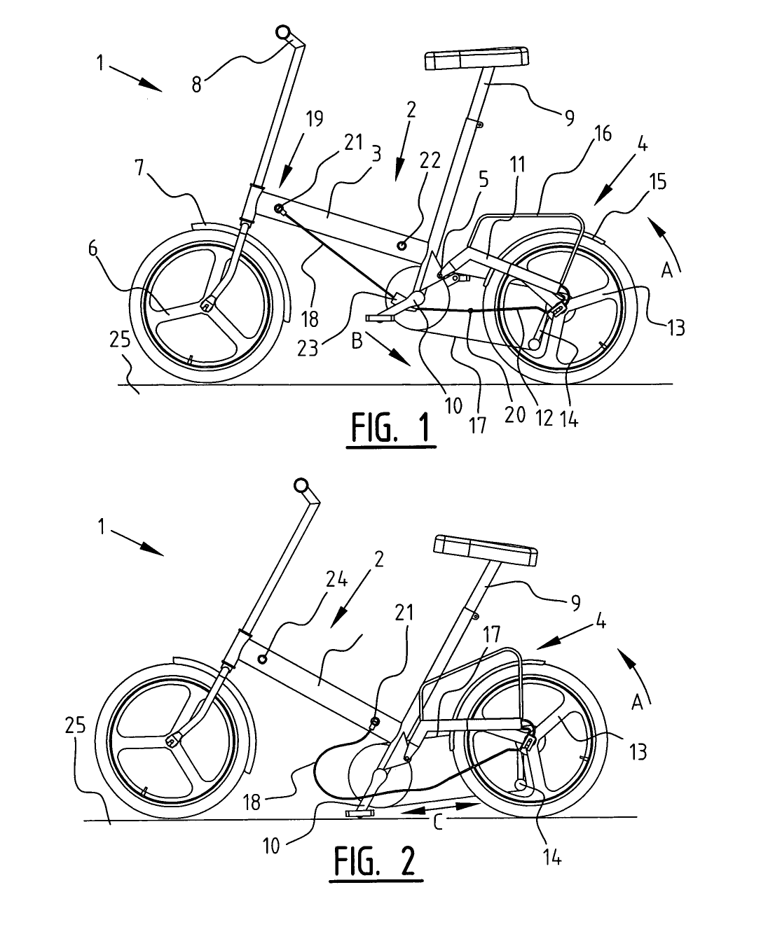

FIG. 2 shows a side view of the vehicle of FIG. 1 in the non-fixated situation of the frame;

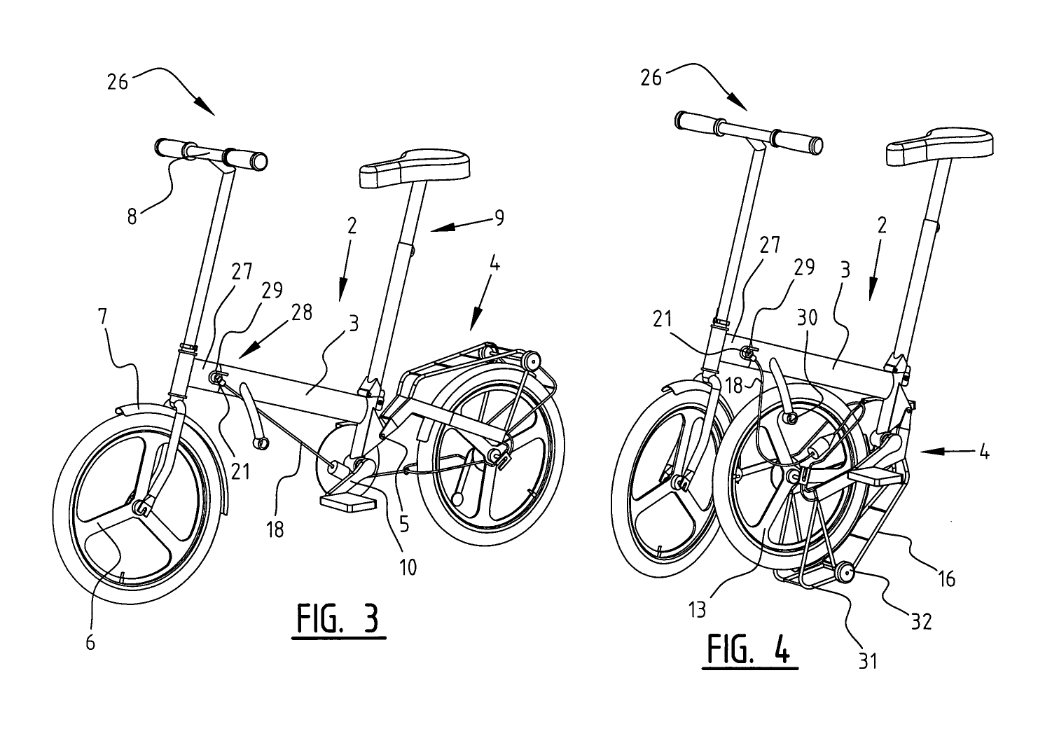

FIG. 3 shows a perspective view of an alternative embodiment of the vehicle of FIG. 1 in the fixated situation of the frame;

FIG. 4 shows a perspective view of the vehicle of FIG. 3 in the non-fixated situation of the frame;

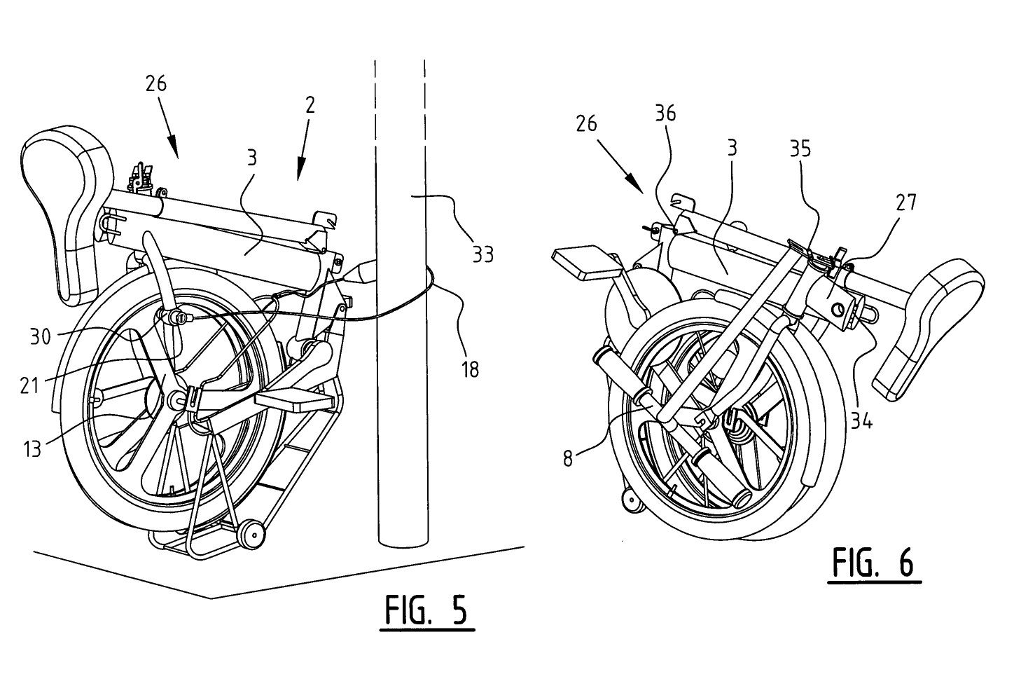

FIG. 5 shows a perspective view of the vehicle of FIG. 3 in the non-fixated situation, secured to a post;

FIG. 6 shows a perspective view of the vehicle of FIG. 5 as seen from a different viewpoint;

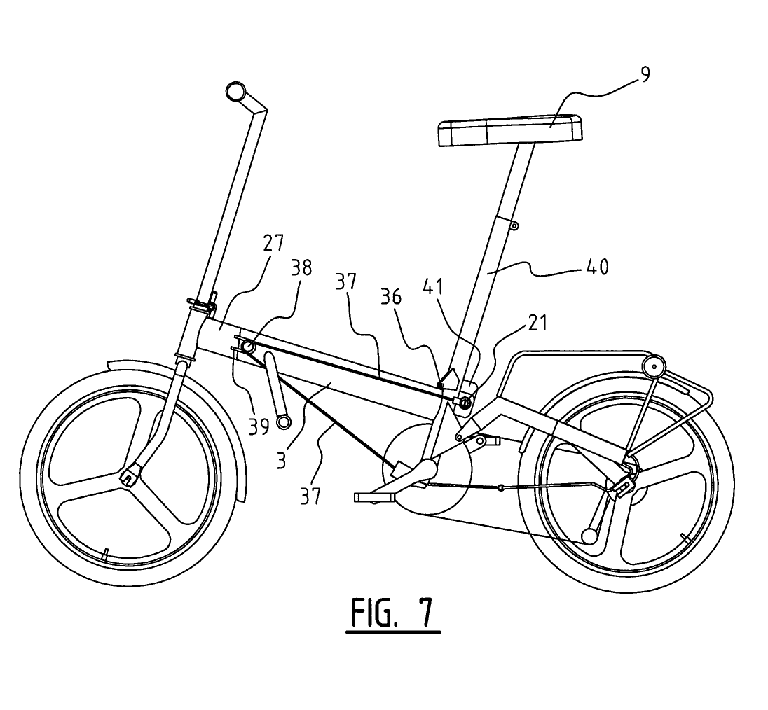

FIG. 7 shows a side view of an alternative embodiment of the vehicle of FIG. 1;

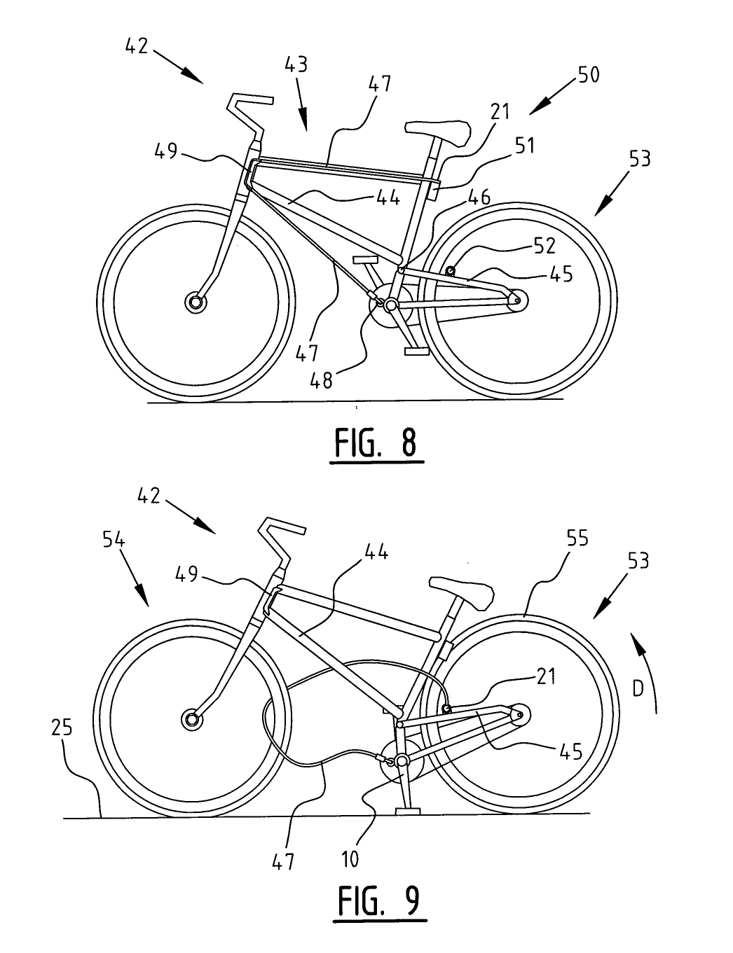

FIG. 8 shows a side view of an alternative embodiment of a vehicle according to the invention in the fixated situation of the frame;

FIG. 9 shows a side view of the vehicle of FIG. 8 in the non-fixated situation of the frame;

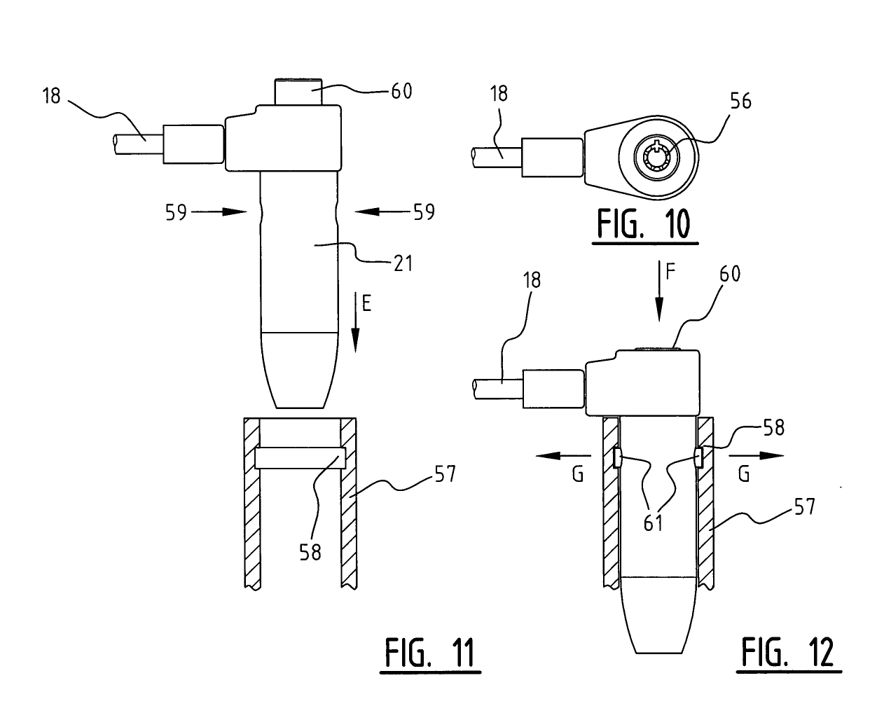

FIG. 10 shows a top view of an embodiment of a coupling part according to the invention;

FIG. 11 shows a side view of the coupling part of FIG. 10 in uncoupled situation;

FIG. 12 shows a side view of the coupling part of FIG. 11 in coupled situation.

FIG. 1 shows a vehicle in the form of a cycle 1. Cycle 1 has a frame 2. Frame 2 has a first frame part 3 and a second frame part 4 which are connected pivotally by means of hinge 5. The rotation axis of hinge 5 is oriented horizontally and is perpendicular to the plane of the drawing. Shown on first frame part 3 are a front wheel 6, a front mudguard 7, a steering device 8, a height-adjustable saddle 9 and a pedal frame 10. The second frame part 4 consists of a bridge-like element 11 and a bracket 12. Shown on second frame part 4 are a drivable rear wheel 13 with gears 14, a rear mudguard 15 and a carrier 16. Bridge-like element 11 can be formed on one side as well as on both sides of rear wheel 13. Shown between pedal frame 10 and drivable rear wheel 13 with gears 14 is a transmission in the form of drive chain 17. Pedal frame 10, drive chain 17 and drivable rear wheel 13 with gears 14 together form the drive. First frame part 3 and second frame part 4 are fixated by means of fixating means in the form of cable 18. Cable 18 engages on first frame part 3 by means of coupling 19 as engaging means securable with a lock, and engages on second frame part 4 by means of engaging means 20. Coupling 19 consist of a pin 21 on cable 18 as first coupling part and a bush (not shown) integrated into first frame part 3 as second coupling part. Pin 21 can be secured in the bush by means of a lock. An integrated second bush 22 as third coupling part is shown in first frame part 3. Pin 21 can also be secured in second bush 22. Cable 18 is in contact along the length thereof with first frame part 3. At the position of this contact a compressible resilient element in the form of a tapering rubber body 23 is shown between cable 18 and first frame part 3. As a result of, among other factors, the weight of first frame part 3, frame part 4 tends to pivot in the direction of arrow A relative to frame part 3. Cable 18 limits the pivoting of frame part 4 in the direction of arrow A relative to frame part 3. In this fixated situation the cycle can be moved freely over ground surface 25. When a rider for instance sits on saddle 9, the tension in cable 18 will increase. The tapering rubber body 23 is herein compressed. During movement of cycle 1 the tapering rubber body 23 forms a suspension. The conical rubber body 23 is displaceable along cable 18. By displacing the tapering rubber body 23 in the direction of arrow B the quantity of rubber material between cable 18 and frame part 3 increases as a result of the tapering form of the body, whereby the suspension behaviour of cycle 1 changes.

FIG. 2 shows cycle 1 with frame 2 in the non-fixated situation. Cable 18 is detached from second coupling part 24 and secured in second bush 22 shown in FIG. 1 by means of pin 21. Cable 18 then no longer fixates first frame part 3 and second frame part 4, whereby, among other reasons as a result of the weight of frame part 3, frame part 4 is pivoted in the direction of arrow A relative to frame part 3. In this non-fixated situation pedal frame 10 comes into contact with ground surface 25, whereby the drive of cycle 1 is obstructed. As a result of the pivoting of frame part 4 in the direction of arrow A relative to frame part 3 the distance C between pedal frame 10 and drivable rear wheel 13 is greater than in the fixated situation of FIG. 1, whereby the distance which drive chain 17 must span is greater. It is known that gears 14 can compensate for a limited increase in distance C. By adapting gears 14 such that they only compensate a partial increase in distance C, it is possible to realize that drive chain 17 allows a pivoting of frame part 4 relative to frame part 3 in the non-fixated situation such that pedal frame 10 does not come into contact with ground surface 25. When a rider then sits on saddle 9, a tension is then applied to drive chain 17 such that the drive of cycle 1 is obstructed. Gears 14 could also be replaced by a hub with a single toothed wheel. A chain tensioner in the form of for instance a toothed wheel can in that case be arranged on a lever in order to compensate, for a small increase in distance C when frame part 4 pivots relative to frame part 3 in the fit-for-use situation.

FIGS. 3-6 show an alternative embodiment of the vehicle of FIGS. 1 and 2. FIG. 3 shows a vehicle in the form of a cycle 26 with a frame 2. Frame 2 has a first frame part 3, a second frame part 4 and a third frame part 27. Frame part 4 is pivotally connected to frame part 3 by means of hinge 5. Frame part 27 is pivotally connected to frame part 3 by means of a hinge (not shown) located on the rear side of the shown frame 2. Shown on third frame part 27 are front wheel 6, front mudguard 7 and steering device 8, and on first frame part 3 the height-adjustable saddle 9 and pedal frame 10.

FIG. 3 shows cycle 26 in the fixated situation. In this situation cable 18 fixates frame parts 3, 4 and 27. The cable engages on frame parts 3 and 27 by means of coupling 28. Coupling 28 consists of a pin 21 on cable 18 as first coupling part, a bracket 29 as second coupling part on frame part 3 and a bush (not shown) integrated into third frame part 27 as additional engaging means.

FIG. 4 shows that frame part 4 is pivoted relative to frame part 3 such that rear wheel 13 is located close to a second coupling part in the form of a bush 30 connected to frame part 3. In order to provide cycle 26 with stable support and mobility in this position of frame part 4 relative to frame part 3, a support bracket 31 and support wheel 32 are shown on carrier 16. The non-fixated situation of frame 2 is realized, from the shown situation, by detaching pin 21 from the bush (not shown) in frame part 27 and bracket 29. Cable 18 can then be used as cable lock by for instance placing it round a post and securing pin 21 in bush 20 using the lock.

FIG. 5 shows cable 18 being used as cable lock round a post 33. Cycle 26 can only be removed by unlocking and detaching pin 21 from bush 30, or by cutting through the cable, after which frame 2 can no longer be placed in the fixated situation. Also shown is that pin 21 extends from bush 30 into rear wheel 13, whereby rotation of rear wheel 13 and pivoting of frame part 4 relative to frame part 3 is obstructed, so that the frame parts cannot be placed in the fit-for-use situation. Also shown is that cycle 26 is further folded up. This is shown more clearly in FIG. 6, in which cycle 26 as shown in FIG. 5 is shown from the other side.

FIG. 6 shows that frame part 27 is pivoted about hinge 34, that steering device 8 is pivoted about hinge 35 and that saddle 9 is pivoted about hinge 36. The size of cycle 26 is hereby reduced considerably. In this folded-up situation the cable can be used not only as cable lock but for instance also as carrying means, for instance round the shoulder. Cable 18 is here not then placed round a post as shown for instance in FIG. 5, but round the shoulder of the owner, wherein the cycle is then carried under the arm and the hands are free, for instance to hold the stair banisters.

FIG. 7 shows an alternative embodiment of cycle 26 of FIGS. 3-6. In this embodiment cable 37 engages on first frame part 3 and third frame part 27 by means of engaging means 38 and 39, and is coupled by means of pin 21 as first coupling part to a bush (not shown), integrated into first frame part 3, as second coupling part. Pivoting of saddle 9 about hinge 36 is here also obstructed by pin 21 because pin 21 protrudes into an engaging means 41 fixedly connected to a fourth frame part 40. Fourth frame part 40 is here fixated by cable 37. In this exemplary embodiment the length of cable 37 is greater than in the exemplary embodiment of FIG. 3. All the frame parts 3, 4, 27 and 40 are fixated by the cable, with the advantage that, in the non-fixated situation of the frame parts, without cable it is extra difficult to make the cycle fit for use.

FIG. 8 shows an alternative embodiment of a vehicle according to the invention. This vehicle in the form of cycle 42 has a frame 43 which is shown in the fixated situation. This frame 43 consists of a sub-frame 44 as first frame part and a sub-frame 45 as second frame part. Sub-frame 44 and sub-frame 45 are mutually connected by means of a hinge 46. A fixating means in the form of cable 47 fixates sub-frame 44 and sub-frame 45 in a fixated situation of frame 43. Cable 47 runs from engaging means 48 on sub-frame 45 to the engaging means on sub-frame 44 in the form of coupling 50 via an engaging means in the form of guide bracket 49 on sub-frame 44. Coupling 50 consists of a pin 21 on cable 47 as first coupling part and a bush 51, fixedly connected to sub-frame 44, as second coupling part. Shown on sub-frame 45 is a second bush 52 as third coupling part, which is located close to rear wheel 53.

FIG. 9 shows cycle 42 of FIG. 8 in the non-fixated situation of frame 43. Relative to the situation in FIG. 8 cable 47 is detached from sub-frame 44 by taking pin 21 out of bush 51 and taking cable 47 out of guide bracket 49. The cable is then passed through front wheel 54 and secured in bush 52 on sub-frame 45 by means of pin 21. Pin 21 here protrudes into rear wheel 53, which for the sake of clarity is shown without spokes or the like. Because cable 47 does not fixate frame 43, sub-frame 45 is pivoted in the direction of arrow D relative to sub-frame 44, as a result of among other factors the own weight of sub-frame 44, whereby the decentral part of rear wheel 53 in the form of tyre 55 has come into contact with sub-frame 44 and pedal frame 10 has come into contact with ground surface 25.

FIGS. 10-12 show a coupling with a pin as first coupling part and a bush as second or third coupling part. FIG. 10 shows a top view of an end of the fixating means in the form of cable 18 with the first coupling part thereon. Integrated into the first coupling part is a lock 56 with which the coupling part can be secured. FIG. 11 shows a side view of the first coupling part of FIG. 10 in non-coupled situation. Pin 21 has an actuating element 60 with which the securing means integrated into pin 21 can be actuated. Pin 21 can be coupled to the second or third coupling part in the form of bush 57 by inserting it therein in the direction of arrow E. Bush 57 is shown with a locking channel 58. FIG. 12 shows that pin 21 of FIG. 11 is inserted into bush 57. Actuating element 60 is pressed in the direction of arrow F, wherein ratchets 61 are pressed in the direction of arrow G out of the holes 59 shown in FIG. 11. Ratchets 61 engage on locking channel 58, whereby pin 21 cannot be taken out of bush 57. With the lock 56 shown in FIG. 10 the actuating element is held in the position shown in FIG. 12 so that pin 21 remains secured in bush 57 until the lock is opened in order to unlock pin 21. Actuating element 60 is herein moved upward and ratchets 61 are retracted into pin 21. Pin 21 can then be taken out of bush 57.

The vehicle is shown in the figures as a cycle. The vehicle can however also be for instance a motorized vehicle, such as for instance an electrically driven cycle, a motorbike, a moped, a cycle with auxiliary motor and the like. It is also possible to envisage other vehicles, such as for instance a reclining cycle, a rollator, a scooter, a hand-cart, a wheelbarrow or even inline skates.

In the figures the fixating means is shown as a cable. The fixating means can however also be a chain, a bar, a bracket or a rod system. The cable can for instance also take a dual form.

The transmission is shown in the figures as a drive chain. The transmission can however also be for instance a drive belt or cardan shaft.

the second coupling part and the third coupling part are shown in the figures on the same side of the frame. It is also possible for one of the two to be arranged on another side or both on the other side. The third coupling part can also be arranged at a position on the vehicle other than on the frame.

The figures show the fixating means with a rubber body as suspension. The rubber body can also be arranged on a frame part. Additionally or alternatively, the fixating means or the frame can also comprise a different suspension, for instance in the form of a draw spring or torsion spring. The shown conical shape of the body can also be different, for instance stepped, wedge-shaped, trapezium-shaped or the like. It is of course also possible to incorporate a damper in the fixating means or the frame, such as a hydraulic or pneumatic damper.

The first coupling part is shown in the figures as a pin and the second and third coupling part as a bush. The first, second and third coupling parts can also be embodied differently. The first coupling part can for instance be a loop and the second and third coupling parts a pin and two bushes fixedly connected to the frame. A coupling is then realized by placing the loop between the two bushes and inserting the pin through the bushes and the loop.

In the figures the frame parts connected for free movement are connected by means of a hinge. These frame parts can for instance also be connected by means of a parallelogram construction or for instance a rail along which one of the frame parts can translate relative to the other frame part.

In the figures the fixating means in the form of a cable is shown as being releasable from the frame parts. The cable can also be non-releasable from the frame parts. The cable can be used particularly in this case as a cable lock by pivoting the frame parts relative to each other such that the cable forms a loop. The loop can then be trained round for instance a post and coupled to the vehicle using a coupling, which coupling can then be secured using a lock.

A securable coupling with lock is shown in the figures at the position of the engagement on the frame part of the fixating means in the form of a cable. The coupling can for instance also be arranged in optionally movable manner along the length of the cable.

The hingedly connected frame parts are shown in the figures with the one wheel on the one frame part and the other wheel on the other frame part. It may also be the case that both wheels are arranged on the one frame part and for instance the saddle or the handlebars on the other frame part. In this case the frame part with the saddle or the handlebars is for instance freely movable relative to the other frame part in the non-fixated situation such that the cycle is not fit for use because the rider cannot sit on the saddle or cannot steer.

The pin and the bush are shown in the figures with a round cross-section. The pin and the bush can for instance also have a partially or wholly non-round, for instance an oval or partially oval cross-section. When the cable is then for instance connected non-centrally to the pin, the cable will attempt to rotate the pin when it is fixated. Because of the non-round form of the pin, the pin is then fixed without play in the bush or two connecting bushes.

1. Vehicle, comprising:
a frame;
one or more wheels on the frame for moving the vehicle over a ground surface;
wherein the frame comprises:
at least two mutually connected frame parts;
a fixating means; and
engaging means with which the fixating means is in engagement with the frame parts;
characterized in that
the frame parts are connected for free movement relative to each other,
wherein
the frame parts are freely movable between a fixated situation, in which the vehicle is fit for use, and a non-fixated situation in which the vehicle is not fit for use; and
the fixating means can fixate the frame parts in the fixated situation,
wherein
the vehicle comprises a coupling to which the fixating means can be coupled;
the coupling comprises a securing means; and
the securing means comprises a lock.

2. Vehicle as claimed in claim 1,
characterized in that
the frame parts are connected for free pivoting relative to each other.

3. Vehicle as claimed in claim 2,
characterized in that
the frame parts are connected for free pivoting by means of a hinge.

4. Vehicle as claimed in claim 3,
characterized in that
the rotation axis of the hinge is oriented substantially horizontally.

5. Vehicle as claimed in any of the foregoing claims,
characterized in that
at least one of the engaging means can be placed releasably in the non-fixated situation round the frame parts.

6. Vehicle as claimed in claim 5,
characterized in that
at least one of the releasable engaging means comprises the coupling.

7. Vehicle as claimed in any of the foregoing claims,
characterized in that
the vehicle comprises a drive which is obstructed in the non-fixated situation.

8. Vehicle as claimed in claim 7,
characterized in that
the drive comprises a pedal frame, wherein the frame parts are movable relative to each other such that in the non-fixated situation the pedal frame comes into contact with the ground surface.

9. Vehicle as claimed in claim 7,
characterized in that
the drive comprises:
a pedal frame on one of the frame parts;
a wheel to be driven via the pedal frame on another frame part; and
a transmission between the pedal frame and the wheel for driving;
wherein the frame parts are movable relative to each other such that the distance between the pedal frame and the driven wheel is greater in the non-fixated situation than in the fixated situation.

10. Vehicle as claimed in any of the foregoing claims,
characterized in that
the frame parts are movable relative to each other such that in the non-fixated situation a part of the vehicle other than the wheels comes into contact with the ground surface.

11. Vehicle as claimed in any of the foregoing claims,
characterized in that
the frame parts are movable relative to each other such that in the non-fixated situation a decentral part of at least one of the wheels comes into contact with a fixed part of the vehicle.

12. Vehicle as claimed in any of the foregoing claims,
characterized in that
the coupling comprises:
a first coupling part on the fixating means; and
a second coupling part on the frame part;
wherein the vehicle comprises a third coupling part to which the first coupling part can be coupled in the non-fixated situation.

13. Vehicle as claimed in claim 12,
characterized in that
the first coupling part comprises a pin;
the third coupling part comprises a bush into which the pin can be inserted;
wherein the length of the bush is smaller than the length of the pin;
wherein the third coupling part is located close to one of the wheels in at least the non-fixated situation; and
wherein the pin extends into this wheel when it is inserted into the bush.

14. Vehicle as claimed in any of the foregoing claims,
characterized in that
the fixating means comprises a cable.

15. Vehicle as claimed in any of the foregoing claims,
characterized in that
the fixating means is in contact along the length thereof with one of the frame parts in the fixated situation.

16. Vehicle as claimed in claim 15,
characterized in that
at the position of the contact a compressible resilient element is arranged between the fixating means and the frame part.

17. Vehicle as claimed in claim 16,
characterized in that
the compressible resilient element is a rubber body.

18. Vehicle as claimed in claim 16 or 17,
characterized in that
the compressible resilient element is displaceable along the fixating means and comprises a tapering form.

19. Vehicle as claimed in any of the foregoing claims,
characterized in that
the frame comprises at least a third frame part which is connected for free movement to at least one of the frame parts;
wherein the third frame part is fixated by means of the fixating means in the fixated situation; and
wherein the frame comprises additional engaging means with which the third frame part is in engagement with the fixating means in the fixated situation.

20. Vehicle as claimed in any of the foregoing claims,
characterized in that
the fixating means is adapted as carrying means.
